(19) United States
(12) Patent Application Publication
(10) Pub. No.: US 2011/0286815 A1
(43) Pub. Date: Nov. 24, 2011

(54) Method and apparatus for molding a high-strength non-metallic fastener having axially-aligned fibers

(76) Inventor: Gary R. Wittman, Costa Mesa, CA (US)

(21) Appl. No.: 12/800,799

(22) Filed: May 24, 2010

(51) Int. Cl. F16B 35/04; B21H 3/02

(52) U.S. Cl. 411/424; 470/8

(57) ABSTRACT

A method and apparatus for molding a high-strength, non-metallic fiber-reinforced threaded fastener, such as a bolt or the like. A non-metallic preform (e.g., a solid rod) having longitudinally-extending fibers running therethrough is located in a mold. A mold insert is positioned at the top of the mold, and a penetrator having a pointed tip is located at the bottom of the mold. Upper and lower press plates are closed against the mold insert and the penetrator. Accordingly, the upper press plate moves the mold insert against the top of the preform in the mold to form the bolt head. The lower press plate moves the penetrator against the bottom of the preform, whereby the penetrator is embedded therewithin. By virtue of the embedded preform, the molded fastener will have axially-extending fibers which are compressed into the threads and run in substantially parallel alignment to better resist failure under load conditions.

### BACKGROUND OF THE INVENTION

1. Field of the Invention

This invention relates to a method and apparatus for molding a high-strength, non-metallic fiber-reinforced fastener (e.g., a threaded bolt). By virtue of embedding a penetrator within a preform during molding, the manufactured fastener has axially-extending fibers which run in substantial parallel alignment with one another from the head of the fastener through the shank and into the threads thereof.

2. Background Art

Referring initially FIG. 1 of the drawings, there is shown the cross-section of a typical threaded bolt 1 that is manufactured from a fiber-reinforced non-metallic material. The bolt 1 has the usual head 3 located at one end thereof, a threaded portion 5 at the opposite end, and a cylindrical shank 7 extending between the head 3 and the threaded portion 5. For the bolt 1 shown in FIG. 1, a plurality of fibers 9 run from the head 3 to the threaded portion 5.

The fibers 9 which run through the bolt 1 are intended to maximize the strength of a fastened system in which the bolt is used. In this regard, it is preferable that the fibers maintain a parallel, axial alignment so that the bolt 1 will be better able to withstand tension forces. However, in many cases, it has been found that under even relatively low loads, the fibers 9 at the threaded portion 5 of bolt 1 tend to compress and become wavy, whereby to turn inwardly and away from the threads so as to wrap up one inside the other (i.e., the fibers are no longer axially aligned). Consequently, the bolt 5 may become weakened at the threaded portion 5 and fail which will negatively impact the structural integrity of the fastened system.

### SUMMARY OF THE INVENTION

In general terms, a method and apparatus are disclosed for molding a non-metallic fiber-reinforced fastener (e.g., a threaded bolt). The fastener is characterized by axially-extending fibers which are maintained in substantially parallel alignment with one another from the head at one end of the fastener to a threaded opposite end so as to maximize the strength of the fastener.

A non-metallic, fiber-reinforced preform (e.g., a solid rod) having longitudinally-extending fibers is located within a preform channel that runs through a mold in which the head, shank and threaded end of the fastener can be formed. A penetrator is detachably connected to a penetrator stand so as to project upwardly therefrom. The penetrator has a pointed tip to facilitate its penetration of the preform. After the penetrator and the preform are first heated, the penetrator is positioned at the bottom of the mold and a mold insert is positioned at the top of the mold between spaced upper and lower plates from a platen press. The press plates are closed towards one another to apply a compressive force against each of the penetrator and the mold insert. Accordingly, the pointed penetrator is pushed into the preform channel at the bottom of the mold so as to be embedded within the preform. At the same time, the mold insert is pushed into a head cavity at the top of the mold to form a relatively wide head. A shank having a threaded end located opposite the head is formed by the mold at a threaded mold portion thereof.

Accordingly, a bolt is manufactured within which the direction of the fibers running therethrough can be controlled. In particular, the fibers are pushed (i.e., compressed) by the embedded penetrator outwardly and into the threads so as to remain relatively straight and in parallel alignment with one another. By virtue of the foregoing, wrinkling or inward folding of the fibers away from the threads of the fastener can be better avoided so as to improve strength and thereby prevent a premature failure of the bolt under load conditions.

### BRIEF DESCRIPTION OF THE DRAWINGS

FIG. 1 shows the cross-section of a conventional non-metallic fiber-reinforced bolt having a pattern of folded fibers running therethrough;

FIG. 2 is an exploded view of an apparatus for molding a high strength, fiber-reinforced, non-metallic bolt according to a preferred embodiment of this invention;

FIG. 3 shows a penetrator to be pushed into a non-metallic preform located in the molding apparatus;

FIG. 4 illustrates the step of molding the preform shown in FIG. 3 within the molding apparatus for manufacturing a finished bolt with the penetrator embedded therewithin; and

FIG. 5 shows the cross-section of the manufactured bolt after being molded according to the present invention so as to have a pattern of relatively straight, axially-aligned fibers running in generally-parallel alignment therethrough.

### DESCRIPTION OF THE PREFERRED EMBODIMENT

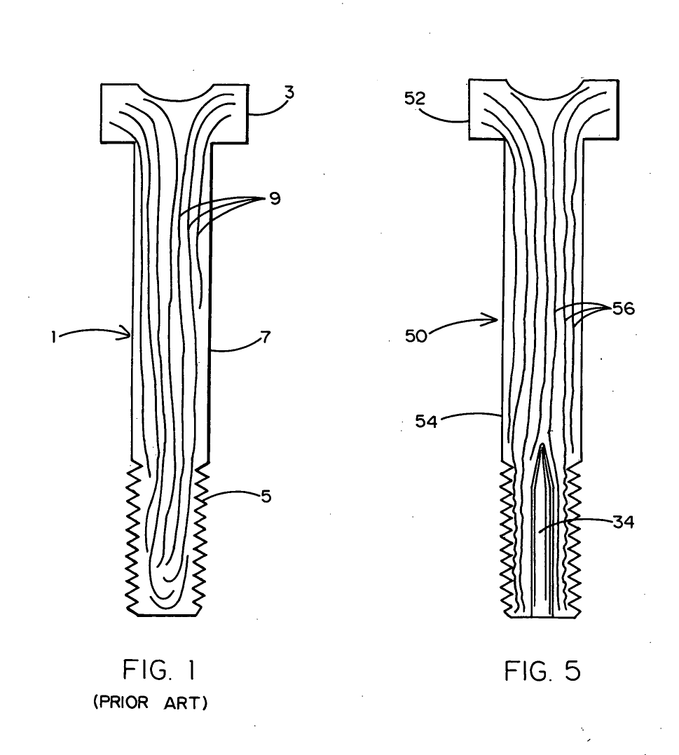

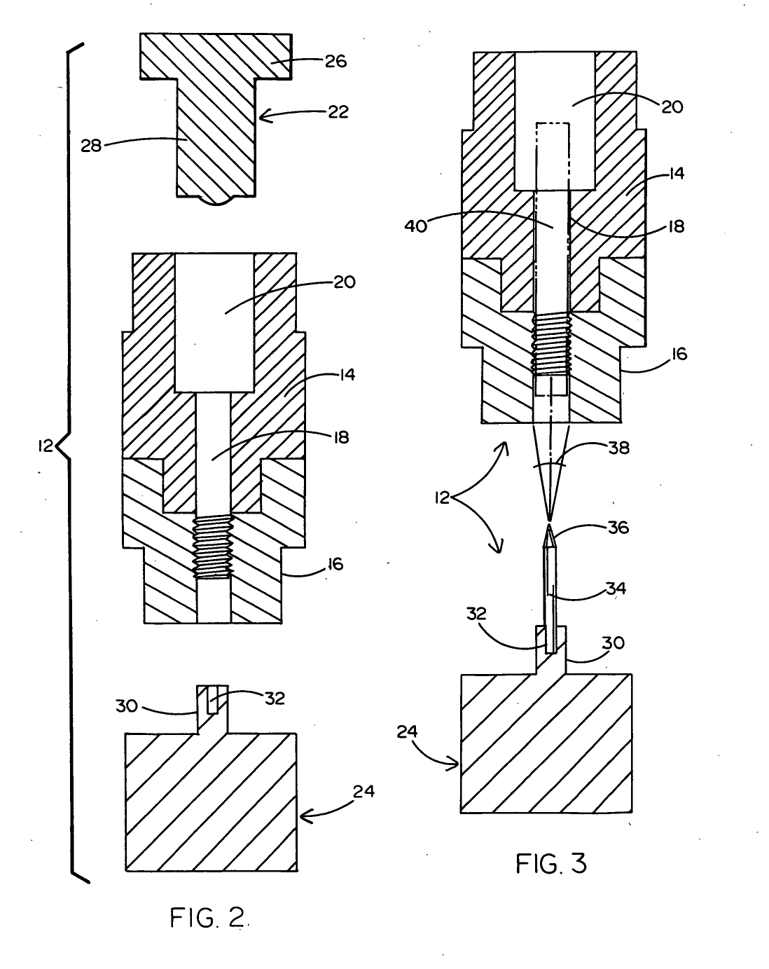

FIG. 2 of the drawings illustrates apparatus 12 for molding a high-strength headed fastener such as a bolt, or the like, and mean for controlling the alignment of fibers extending between opposite ends of the fastener so as to enable a parallel, axial alignment thereof. By virtue of the foregoing, the molded fastener will be better able to withstand pulling forces and thereby avoid early failure under load conditions when compared with the bolt 1 shown in FIG. 1. In order to maximize its strength under tension loads, the fastener to be molded by the apparatus 12 is ideally manufactured from a non-metallic (e.g., composite) material having non-metallic fibers running therethrough.

The apparatus 12 for molding the high-strength headed fastener includes a shank and head mold 14 that is seated upon and mated to a thread mold 16. A narrow preform channel 18 extends longitudinally through the shank and head mold 14 and the thread mold 16 of apparatus 1. A relatively wide head cavity 20 is formed in the shank and head mold 14 so as to lie at the top of the preform channel 18.

The molding apparatus 12 also includes a mold insert 22 and a lower base 24. Both the mold insert 22 and the base 24 are preferably manufactured from heat-treated tool steel. The mold insert 22 has a cap 26 at the top and a punch 28 extending downwardly from the cap. The punch 28 of insert 22 is sized to be received within the head cavity 20 of the shank and head mold 14 atop the preform channel 18. The lower base 24 includes a penetrator stand 30 projecting upwardly therefrom. The penetrator stand 30 is sized to be received within the preform channel 18 at the bottom of the thread mold 16.

Turning to FIG. 3 of the drawings, as an important feature of the present invention, a penetrator 34 is shown standing upwardly from and detachably connected at one end thereof at a cavity 32 formed in the penetrator stand 30 of the lower base 24. The penetrator 34 has a pointed tip 36 at the opposite end. The pointed tip 36 of the penetrator 34 forms an angle 38 (of, for example, 18 degrees). The penetrator 34 can be manufactured from either one of a lightweight metallic or non-metallic (e.g., composite) material. Although it is shown in FIG. 3 as being solid, the penetrator 34 may also have a hollow body. Moreover, the penetrator 34 can be reinforced with fibers for added strength.

FIG. 3 also shows a non-metallic preform (shown in phantom lines) 40 to be molded by the molding apparatus 12. The preform 40 is, for example, a solid (e.g., composite) rod that is capable of being molded so as to create a threaded bolt or a similar fastener. The preform 40 includes a plurality of non-metallic (e.g., ceramic, carbon or glass) fibers (best shown in FIG. 5) running longitudinally therethrough. A first end of the preform 40 to be threaded is located within preform channel 18 at the thread mold 16 of molding apparatus 12. The opposite end of the preform 40 to be headed projects upwardly through the shank and head mold 14 for receipt within the head cavity 20.

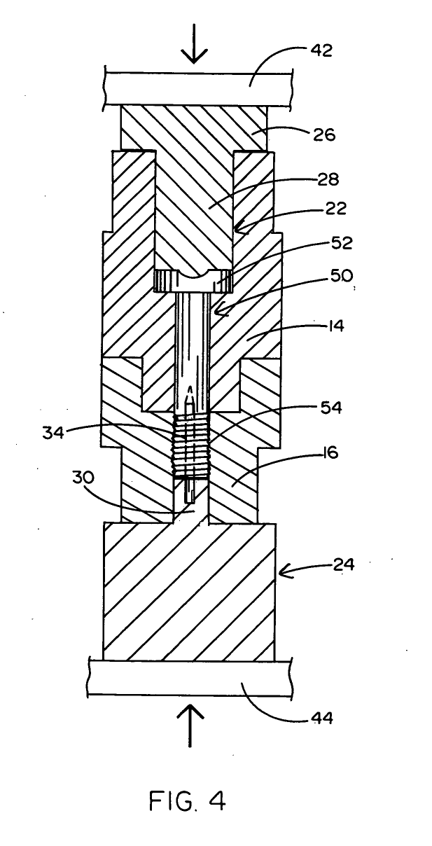

The steps for forming a high-strength headed fastener, such as a bolt or the like, are now described while referring to FIGS. 3 and 4 of the drawings. The base 24 which carries the upstanding pointed penetrator 34 is initially located within a mold housing (not shown) where the base and penetrator are heated to a temperature of about 460 degrees F. The mold shank and head mold 14, the thread mold 16 and the mold insert 22 are all located within an oven (also not shown) where they are heated to a temperature of about 750 degrees F. Once heated, the molds 14 and 16 as well as the mold insert 22 are removed from the oven and relocated to the mold housing with the base 24 at which time pressure is applied to form the head and enable the penetrator 34 to penetrate the preform 40. Cooling is then permitted to enable the molded material to harden.

More particularly, and as is best illustrated in FIG. 4, the punch 28 of the mold insert 22 is located inwardly of the head cavity 20 at the top of the shank and head mold 14, and the penetrator stand 30 of the lower base 24 is located inwardly of the preform channel 18 at the bottom of the thread mold 16. Thus, the penetrator 34 which projects upwardly from the penetrator stand 30 of lower base 24 and the punch 28 which projects downwardly from the cap 26 of mold insert 22 are positioned in opposing axial alignment with the preform 40 located within the preform channel 18.

Next, while the preform 40 is still hot, spaced upper and lower plates 42 and 44 (of FIG. 4) from a platen press are moved into engagement with the cap 26 of the mold insert 22 and the lower base 24. The upper and lower platen plates 42 and 44 are closed towards one another so as to cause pressure (in the direction of the reference arrows of FIG. 4) to be applied to the mold insert 22 and the lower base 24 to compress and shape the preform 40. The combination of heat and pressure causes the preform to be molded into a non-metallic (e.g., composite) fiber-reinforced fastener (e.g., bolt 50). That is, the receipt of the punch 28 of mold insert 22 against the preform 40 within the head cavity 28 of the shank and head mold 14 forms the head (designated 52 in FIG. 5) of the bolt 50. The shank (designated 54 in FIG. 5) of bolt 50 is formed with a threaded end by the thread mold 16. At the same time, the pointed penetrator 34 (of FIG. 3) is pushed through the preform channel 18 and into the threaded shank 54 by the compressive force that is applied to the lower base 24 by the lower platen plate 44.

At the conclusion of the molding process after the manufactured bolt 50 has cooled to a hard consolidated consistency, the upper and lower platen plates 42 and 44 are opened and moved away from one another, and the mold insert 22 and lower base 24 are withdrawn from the molds 14 and 16 and allowed to cool to near room temperature. The penetrator 34 which is embedded within the threaded end of the shank 54 of bolt 50 is now detached from the cavity 32 of penetrator stand 30. The bolt 50 is then removed from the molds 14 and 16. In some cases, because of its length, the penetrator 34 may protrude from the bottom of the shank 54. Therefore, any excessive length or protrusion of the penetrator 34 from the manufactured bolt 50 is machined (e.g., ground) off so that the bolt will be ready for use.

By virtue of molding the non-metallic, fiber-reinforced bolt 50 with the penetrator 34 embedded therewithin, and turning now to FIG. 5 of the drawings, the fibers 56 which run longitudinally through the shank 54 are pushed and compressed outwardly into the threads. Moreover, rather than wrinkling inwardly and away from the threads or folding up in the manner illustrated at FIG. 1, the fibers 56 of the bolt 50 of FIG. 5 run axially and in generally parallel alignment with one another through the shank 54 to the threaded end. In other words, the embedded penetrator 34 enables the direction of the fibers 56 to be controlled so as to remain relatively straight and thereby maximize the strength of the bolt 50 at the threaded end of shank 54 in order to advantageously avoid an early failure thereof under load conditions.

While FIG. 5 illustrates the penetrator 34 embedded within a bolt 50, the advantages derived from the penetrator as described above are also applicable to molding other high-strength, non-metallic fasteners whether headed or not and having threads at one or both ends. One example of such an additional fastener within which the penetrator 34 may be embedded is a stud (not shown) that is threaded at each end.

1. A fastener comprising a first end, an opposite end with threads formed therein, a plurality of fibers running longitudinally between said first end and said opposite end, and a penetrator embedded within said opposite end, said penetrator pushing said plurality of fibers towards and into said threads so that said fibers extend axially and in generally parallel alignment at said opposite end.

2. The fastener recited in claim 1, wherein said fastener is a bolt having a head at said first end.

3. The fastener recited in claim 1, wherein said penetrator has a pointed tip to penetrate said opposite end.

4. The fastener recited in claim 1, wherein said penetrator is manufactured from a metallic material.

5. The fastener recited in claim 1, wherein said penetrator is manufactured from a non-metallic material.

6. A method for making a high-strength fastener having a first end, an opposite end with threads formed therein, and a plurality of fibers which run longitudinally between said first end and said opposite end, said method comprising the steps of:
locating a preform within a mold having a thread forming section;
applying heat and pressure to the preform within the mold to form the threads of said fastener at the thread forming section; and
locating a penetrator within said preform so that the plurality of fibers which run between the first end and the opposite end of said fastener are pushed into said threads and extend axially and in generally parallel alignment with one another.

7. The method for making a high-strength fastener recited in claim 6, including the additional steps of detachably connecting said penetrator to a penetrator stand, and pushing said penetrator from said penetrator stand into the preform such that said penetrator is embedded within said fastener at the opposite end thereof.

8. The method for making a high-strength fastener recited in claim 7, including the additional step of moving said penetrator stand into the thread forming section of the mold at which said penetrator is pushed into the preform.

9. The method for making a high-strength fastener recited in claim 6, including the additional steps of axially aligning said penetrator with the preform, and forcing said penetrator into the preform such that said penetrator is embedded within said fastener at the opposite end thereof.

10. The method for making a high-strength fastener recited in claim 6, including the additional step of locating the mold in a heated oven to apply the heat to the preform, removing the mold from the oven and positioning the mold between a pair of opened press plates, and closing the press plates towards one another to apply the pressure to the preform.

11. The method for making a high-strength fastener recited in claim 6, including the additional step of applying heat and pressure to the preform to form a head at the first end of the fastener within a head forming section of the mold.
